(19) United States
(12) Patent Application Publication
(10) Pub. No.: US 2012/0139794 A1
(43) Pub. Date: Jun. 7, 2012

(54) MULTI-BAND ANTENNA

(76) Inventors: Jia-Hung Su, Taipei (TW); Kai Shih, Taipei (TW)

(21) Appl. No.: 12/960,457

(22) Filed: Dec. 3, 2010

(51) Int. Cl. H01Q 5/00; H01Q 9/04

(52) U.S. Cl. 343/700 MS

(57) ABSTRACT

A multi-band antenna includes a base plate, a first radiating element and a second radiating element. The base plate has a transverse front edge and a longitudinal side edge perpendicular to the transverse front edge. A feeding portion and a ground portion are extended frontward and then bent downward from two spaced portions of the transverse front edge. The first radiating element is substantially lying L-shaped and connected with one end of the base plate adjacent to the feeding portion. The first radiating element includes a first connection section, a first extension section and a second extension section. The second radiating element includes a first radiating strip, a short second connection section, a second radiating strip, a third connection section and a third radiating strip.

### BACKGROUND OF THE INVENTION

1. Field of the Invention

The present invention relates to a multi-band antenna, and more particularly to a built-in multi-band antenna capable of being assembled to a portable wireless communicating device conveniently.

2. The Related Art

With the development of wireless communication technology, more and more portable wireless communicating devices, such as mobile phones and notebooks, are installed antenna systems for working in wireless wide area network (WWAN) systems. It's a trend for the wireless communicating device to have multiple wireless wide area network systems therein so as to make the mobile phones keep a good communicating performance anywhere. Moreover, among present wireless technologies, wireless communication bands include advanced mobile phone communication system (AMPS) band ranged from 824 MHZ to 894 MHZ, global system for mobile communication (GSM) band ranged from 880 MHZ to 960 MHZ, digital communication system (DCS) band ranged from 1710 MHZ to 1880 MHZ or personal communication system (PCS) band ranged from 1850 MHZ to 1990 MHZ and so on.

However, many different types of antennas for the portable wireless communication devices are used, occupied space of the used antennas are larger, and manufacturing cost is higher. Furthermore, all of these antennas could not meet the demand of operating at multiple frequencies while the sizes thereof are reduced.

### SUMMARY OF THE INVENTION

An object of the present invention is to provide a multi-band antenna. The multi-band antenna includes a base plate, a first radiating element and a second radiating element. The base plate has a transverse front edge and a longitudinal side edge perpendicular to the transverse front edge and connected to the transverse front edge. A feeding portion and a ground portion are extended frontward and then bent downward from two spaced portions of the transverse front edge. The first radiating element of substantially lying L shape includes a first connection section extended frontward and inclined downward from an end of the transverse front edge adjacent to the longitudinal side edge, a first extension section extended frontward and then bent downward from a free end of the first connection section to show a substantially inverted-L shape, and a second extension section extended opposite to the base plate from a lower end of the first extension section. The second radiating element includes a first radiating strip extended opposite to the base plate from a rear end of the longitudinal side edge away from the first radiating element, a second connection section extended perpendicularly rearward from a distal end of the first radiating strip, a second radiating strip extended opposite to the first radiating strip from a rear end of the second connection section, a third connection section bent forward from a distal end of the second radiating strip, and a third radiating strip extended towards the first extension section form a free end of the third connection section with a distal end thereof adjacent to the first extension section and located above the second extension section.

As described above, the arrangement of the first radiating element and the second radiating element makes the multi-band antenna transmit and receive multiple bands covering DCS 1710˜1880 MHZ, PCS 1850˜1990 MHZ, AMPS 824˜894 MHZ and GSM 880˜960 MHZ. Furthermore, the multi-band antenna is of a bending and miniaturized structure for conveniently being assembled in the portable wireless communication device, which makes the multi-band antenna occupy smaller space when assembled in a portable wireless communication device, and the manufacturing cost lower.

### BRIEF DESCRIPTION OF THE DRAWINGS

The present invention will be apparent to those skilled in the art by reading the following description, with reference to the attached drawings, in which:

FIG. 1 is a perspective view illustrating the structure of a multi-band antenna of an embodiment in accordance with the present invention.

### DETAILED DESCRIPTION OF THE PREFERRED EMBODIMENT

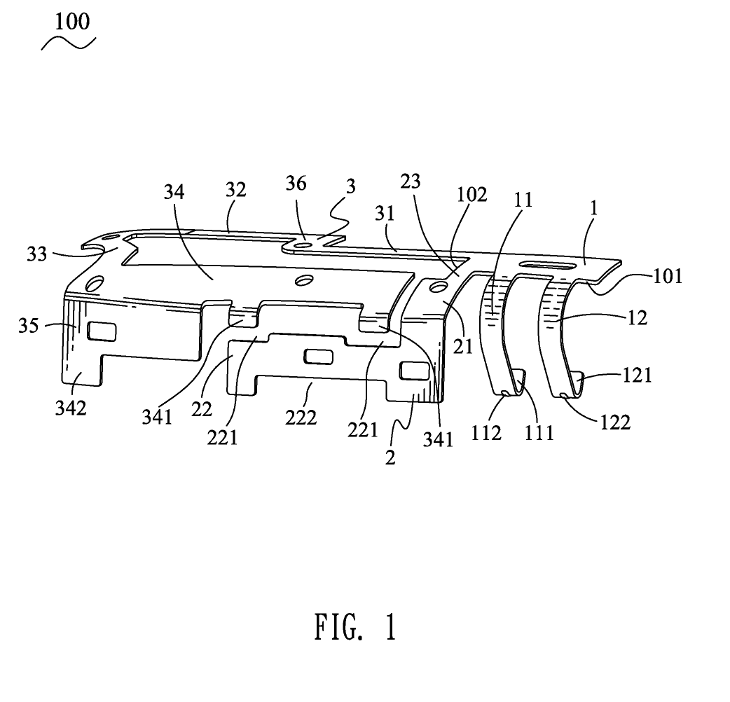

Referring to FIG. 1, an embodiment of a multi-band antenna 100 according to the present invention is shown. The multi-band antenna 100 which may be formed by pattern etching a copper-plated sheet of synthetic material includes a base plate 1, a first radiating element 2 and a second radiating element 3.

The base plate 1 is of a substantially rectangular shape, and disposed horizontally and extended transversely. The base plate 1 has a transverse front edge 101, and a longitudinal side edge 102 perpendicular to the transverse front edge 101 and connected to the transverse front edge 101. A feeding portion 11 and a ground portion 12 are extended frontward and then bent downward from two spaced portions of the transverse front edge 101. A free end of the feeding portion 11 and a free end of the ground portion 12 are respectively bent upward and rearward to form a feeding elastic portion 111 and a ground elastic portion 121. An outer surface of the feeding elastic portion 111 and an outer surface of the ground elastic portion 121 are respectively protruded outward to form a feeding point 112 and a ground point 122. The feeding portion 11 is closer to the first radiating element 2 than the ground portion 12 and arranged away from the base plate 1.

The first radiating element 2 is substantially lying L-shape and includes a first connection section 23, a first extension section 21 and a second extension section 22. The first connection section 23 is extended frontward and inclined downward from an end of the transverse front edge 101 adjacent to the longitudinal side edge 102. The first extension section 21 is extended frontward and then bent downward from a free end of the first connection section 23 to show a substantially inverted-L shape. The second extension section 22 is extended opposite to the base plate 1 from a lower end of the first extension section 21. Two ends of a top of the second extension section 22 are concaved downward to form two first recesses 221. A middle of a bottom of the second extension section 22 is cut off to form a second recess 222.

The second radiating element 3 coplanar with the base plate 1 includes a first radiating strip 31, a short second connection section 36, a second radiating strip 32, a third connection section 33 and a third radiating strip 34. The first radiating strip 31 is of an elongated shape and extended opposite to the base plate 1 from a rear end of the longitudinal side edge 102 away from the first radiating element 2. The second connection section 36 is extended perpendicularly rearward from a distal end of the first radiating strip 31. The second radiating strip 32 is of an elongated shape and extended opposite to the first radiating strip 31 from a rear end of the second connection section 36. The third connection section 33 is bent frontward from a distal end of the second radiating strip 32. The third radiating strip 34 is extended towards the first extension section 21 from a free end of the third connection section 33 with a distal end thereof adjacent to the first extension section 21 and located above the second extension section 22. A bending plate 35 is bent downward from one end of an outer side of the third radiating strip 34 away from the first extension section 21 with a distal end adjacent to and spaced apart from a distal end of the second extension section 22. An end of a bottom of the bending plate 35 away from the second extension section 22 extends downward to form a second fixing section 342. Two portions of the other end of the outer side of the third radiating strip 34 extend downward to form two first fixing sections 341, respectively.

When the multi-band antenna 100 is used in wireless communication, the electric current is fed into the multi-band antenna 100 via the feeding point 112. The first radiating element 2 produces a main resonance mode to secure the first radiating element 2 for transmitting and receiving a higher frequency range covering DCS 1710˜1880 MHZ and PCS 1850˜1990 MHZ; while the second radiating element 3 produces a main resonance mode to secure the second radiating element 3 for transmitting and receiving a lower frequency range covering AMPS 824˜894 MHZ and GSM 880˜960 MHZ. Therefore, the multi-band antenna 100 obtains frequency range corresponding to DCS band, PCS band, AMP band and GSM band in wireless communication.

As described above, the arrangement of the first radiating element 2 and the second radiating element 3 makes the multi-band antenna 100 transmit and receive multiple bands covering DCS 1710˜1880 MHZ, PCS 1850˜1990 MHZ, AMPS 824˜894 MHZ and GSM 880˜960 MHZ. Furthermore, the multi-band antenna 100 is of a bending and miniaturized structure for conveniently being assembled in the portable wireless communication device, which makes the multi-band antenna 100 occupy smaller space when assembled in a portable wireless communication device, and the manufacturing cost lower.

What is claimed is:

1. A multi-band antenna, comprising:
a base plate having a transverse front edge and a longitudinal side edge perpendicular to the transverse front edge and connected to the transverse front edge, a feeding portion and a ground portion extended frontward and then bent downward from two spaced portions of the transverse front edge;
a first radiating element of substantially lying L shape and including a first connection section extended frontward and inclined downward from an end of the transverse front edge adjacent to the longitudinal side edge, a first extension section extended frontward and then bent downward from a free end of the first connection section to show a substantially inverted-L shape, and a second extension section extended opposite to the base plate from a lower end of the first extension section; and
a second radiating element coplanar with the base plate including a first radiating strip extended opposite to the base plate from a rear end of the longitudinal side edge away from the first radiating element, a second connection section extended perpendicularly rearward from a distal end of the first radiating strip, a second radiating strip extended opposite to the first radiating strip from a rear end of the second connection section, a third connection section bent forward from a distal end of the second radiating strip, and a third radiating strip extended towards the first extension section form a free end of the third connection section with a distal end thereof adjacent to the first extension section and located above the second extension section.

2. The multi-band antenna as claimed in claim 1, wherein a bending plate is bent downward from one end of an outer side of the third radiating strip away from the first extension section with a distal end adjacent to and spaced apart from a distal end of the second extension section.

3. The multi-band antenna as claimed in claim 2, wherein a bottom of the bending plate away from the second extension section extends downward to form a second fixing section.

4. The multi-band antenna as claimed in claim 2, wherein two portions of the other end of the outer side of the third radiating strip adjacent to first radiating element extend downward to form two first fixing sections.

5. The multi-band antenna as claimed in claim 4, wherein two ends of a top of the second extension section are concaved downward to form two first recesses, a bottom of the second extension section defines a second recess.

6. The multi-band antenna as claimed in claim 1, wherein the feeding portion is closer to the first radiating element than the ground portion and arranged away from the base plate.

7. The multi-band antenna as claimed in claim 1, wherein the first radiating element works at a higher frequency range covering DCS 1710˜1880 MHZ and PCS 1850˜1990 MHZ, the second radiating element works at a lower frequency range covering AMPS 824˜894 MHZ and GSM 880˜960 MHZ.
